(19) United States
(12) Patent Application Publication
(10) Pub. No.: US 2017/0329501 A1
(43) Pub. Date: Nov. 16, 2017

(54) IMAGE ANALYSIS SYSTEM

(71) Applicant: Konica Minolta, Inc., Tokyo (JP)

(72) Inventors: Akinori TSUNOMORI, Tokyo (JP); Hitoshi FUTAMURA, Tokyo (JP)

(21) Appl. No.: 15/491,624

(22) Filed: Apr. 19, 2017

(30) Foreign Application Priority Data
May 10, 2016 (JP) 2016-094316

(51) Int. Cl. G06F 3/0484; G06T 3/40; G06T 11/60

(52) U.S. Cl. CPC G06F 3/04845; G06T 11/60; G06T 3/40; G06T 2200/24

(57) ABSTRACT

An image analysis system, including: a display apparatus which displays a medical image or an analysis result image that shows analysis results at respective positions of a plurality of sub-regions in the medical image, the analysis results being obtained by performing analysis for the respective sub-regions in the medical image; and a control apparatus which, when a target region is set by an operation of a pointing device on the medical image or the analysis result image that is displayed by the display apparatus, controls the display apparatus to display, at a position of the target region or around the target region, an image of a position corresponding to the target region in the medical image or the analysis result image which is different from an image displayed outside a range of the target region.

### CROSS-REFERENCE TO RELATED APPLICATIONS

The entire disclosure of Japanese Patent Application No. 2016-094316 filed on May 10, 2016 including description, claims, drawings and abstract are incorporated herein by reference in its entirety.

### BACKGROUND OF THE INVENTION

### 1. Field of the Invention

The present invention relates to an image analysis system.

### 2. Description of Related Art

In recent years, attempts have been made to use semiconductor image sensors such as FPDs (flat panel detectors) for capturing dynamic images at diagnosis target sites and use the dynamic images for diagnosis.

For example, Patent document 1 (International Publication No. 2012/026145) describes displaying images next to each other on a same screen, the images being a dynamic image of a chest, a moving image showing analysis results of a ventilation function for respective sub-regions in lung field regions of the dynamic image at corresponding positions in the lung field regions, and a moving image showing analysis results of a blood flow function for respective sub-regions in the lung field regions of the dynamic image at corresponding positions in the lung field regions. The Patent document 1 also describes that a waveform of a signal value or the like showing a ventilation amount in a sub-region is separately displayed when the sub-region on the moving image is selected by a mouse or the like. The Patent document 1 further describes displaying operation buttons for instructing play, advance, pause and such like of the moving image on the screen.

In general diagnosis by a doctor, a target region which possibly has a lesion is first determined by observing a medical image (morphologic image) obtained by photographing a site of the diagnosis target. Then, diagnosis is performed by referring to analysis results (functional information) for the determined target region. However, on the screen described in the Patent document 1, the medical image and the analysis result images are next to each other, and it is difficult for a doctor to perform observation by associating the target region between images while moving his/her gaze between such a plurality of images. Even if the target region can be associated, the doctor's gaze is also distracted to information on regions other than the target region, and thus, it is difficult to perform observation with concentration on the target region. In a case where the medical image and the analysis result images are moving images, for a target region on one moving image, it is not possible to simultaneously observe another moving image. Furthermore, setting regarding analysis, display and such like needs to be performed by the operation buttons which are separately provided, and thus, the operation is troublesome.

### SUMMARY OF THE INVENTION

An object of the present invention is to enable a user to easily observe another image corresponding to a target region which was set on any of a medical image or analysis result images thereof.

In order to solve the above problems, according to one aspect of the present invention, there is provided an image analysis system, including: a display apparatus which displays a medical image or an analysis result image that shows analysis results at respective positions of a plurality of sub-regions in the medical image, the analysis results being obtained by performing analysis for the respective sub-regions in the medical image; and a control apparatus which, when a target region is set by an operation of a pointing device on the medical image or the analysis result image that is displayed by the display apparatus, controls the display apparatus to display, at a position of the target region or around the target region, an image of a position corresponding to the target region in the medical image or the analysis result image which is different from an image displayed outside a range of the target region.

### BRIEF DESCRIPTION OF THE DRAWINGS

The above and other objects, advantages and features of the present invention will become more fully understood from the detailed description given hereinafter and the appended drawings which are given byway of illustration only, and thus are not intended as a definition of the limits of the present invention, and wherein:

FIG. 1 is a view showing an entire configuration of an image analysis system in an embodiment of the present invention;

FIG. 2 is a flowchart showing display control processing executed by a control section of a diagnostic console in FIG. 1;

FIG. 3 is a view for explaining an operation of a pointing device for setting a target region;

FIG. 4 is a view showing four types of traces when a target region is set;

FIG. 5A is a view showing an example of displaying an analysis result image in a target region on a dynamic image;

FIG. 5B is a view showing an example of displaying another analysis result image in a target region on an analysis result image;

FIG. 6 is a view showing an operation of the pointing device for changing the size of the target region;

FIG. 7 is a view showing an operation of the pointing device for changing the position of the target region;

FIG. 8 is a view showing an operation of the pointing device for additionally displaying another analysis result image;

FIG. 9 is a view showing an operation of the pointing device for changing an image to be displayed in the target region;

FIG. 10 is a view showing an operation of the pointing device for setting a plurality of target regions; and

FIG. 11 is a view showing a display example in a case where related images are arranged around the target region.

### DETAILED DESCRIPTION OF THE PREFERRED EMBODIMENT

Hereinafter, an embodiment of the present invention will be described in detail with reference to the drawings. However, the scope of the present invention is not limited to the illustrated examples.

### <Configuration of Image Analysis System 100>

First, the configuration will be described.

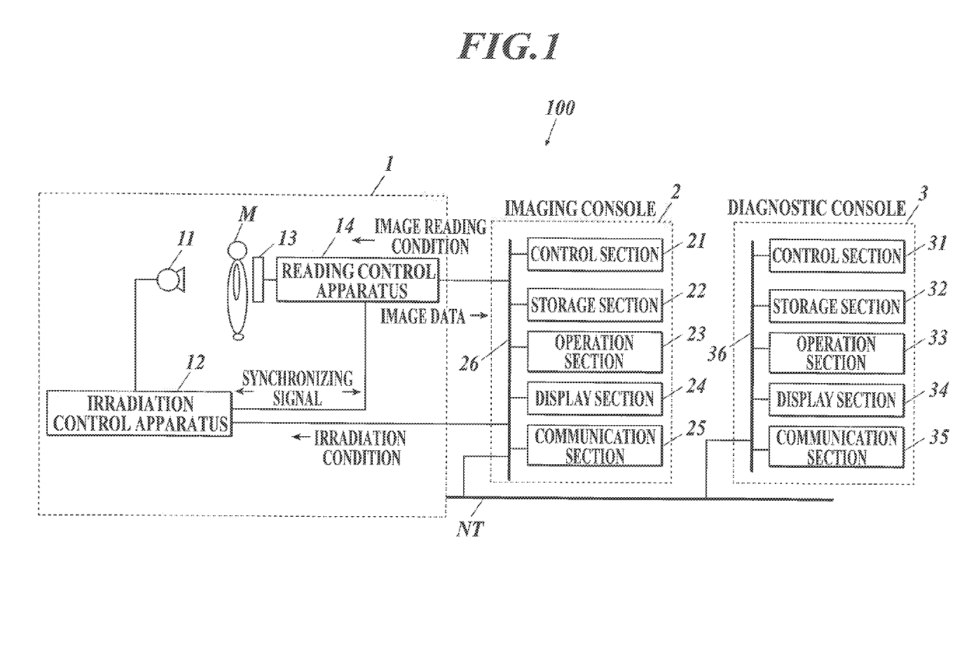

FIG. 1 shows the entire configuration of an image analysis system 100 in the embodiment.

As shown in FIG. 1, the image analysis system 100 is configured by connecting an imaging apparatus 1 to an imaging console 2 by a communication cable or the like, and connecting the imaging console 2 to a diagnostic console 3 via a communication network NT such as a LAN (Local Area Network). The apparatuses forming the image analysis system 100 are compliant with the DICOM (Digital Image and Communications in Medicine) standard, and the apparatuses are communicated with each other according to the DICOM.

### <Configuration of Imaging Apparatus 1>

The imaging apparatus 1 is an imaging section which performs image capturing of a dynamic state of a chest having a cycle such as morphological changes of inflation and deflation of lungs according to the respiratory motion and the heart beat, for example. The dynamic imaging means obtaining a plurality of images showing a dynamic state by repeatedly emitting a pulsed radiation such as X-ray to a subject at a predetermined time interval (pulse irradiation) or continuously emitting the radiation (continuous irradiation) at a low dose rate without interruption. A series of images obtained by the dynamic imaging is referred to as a dynamic image. Each of the plurality of images forming the dynamic image is referred to as a frame image. Hereinafter, the embodiment will be described by taking, as an example, a case where the dynamic imaging is performed by pulse irradiation.

A radiation source 11 is located at a position facing a radiation detection section 13 through a subject M, and emits radiation (X ray) to the subject M in accordance with control of an irradiation control apparatus 12.

The irradiation control apparatus 12 is connected to the imaging console 2, and performs radiation imaging by controlling the radiation source 11 on the basis of irradiation conditions which were input from the imaging console 2. The irradiation conditions input from the imaging console 2 include a pulse rate, a pulse width, a pulse interval, the number of imaging frames per imaging, a value of X-ray tube current, a value of X-ray tube voltage and a type of applied filter, for example. The pulse rate is the number of irradiation per second and consistent with an after-mentioned frame rate. The pulse width is an irradiation time required for one irradiation. The pulse interval is a time from start of one irradiation to start of the next irradiation, and consistent with an after-mentioned frame interval.

The radiation detection section 13 is configured by including a semiconductor image sensor such as an FPD. The FPD has a glass substrate, for example, and a plurality of detection elements (pixels) is arranged in matrix at a predetermined position on the substrate to detect, according to the intensity, at least radiation which was emitted from the radiation source 11 and has transmitted through the subject M, and convert the detected radiation into electric signals to be accumulated. Each pixel is formed of a switching section such as a TFT (Thin Film Transistor), for example. The FPD may be an indirect conversion type which converts X ray into an electrical signal by a photoelectric conversion element via a scintillator, or may be a direct conversion type which directly converts X ray into an electrical signal.

The radiation detection section 13 is provided to face the radiation source 11 via the subject M.

The reading control apparatus 14 is connected to the imaging console 2. The reading control apparatus 14 controls the switching sections of respective pixels in the radiation detection section 13 on the basis of image reading conditions input from the imaging console 2, switches the reading of electric signals accumulated in the pixels, and reads out the electric signals accumulated in the radiation detection section 13 to obtain image data. The image data is a frame image. The reading control apparatus 14 outputs the obtained frame image to the imaging console 2. The image reading conditions include a frame rate, a frame interval, a pixel size, an image size (matrix size) and such like. The frame rate is the number of frame images obtained per second and consistent with the pulse rate. The frame interval is a time from start of obtaining one frame image to start of obtaining the next frame image, and consistent with the pulse interval.

Here, the irradiation control apparatus 12 and the reading control apparatus 14 are connected to each other, and transmit synchronizing signals to each other to synchronize the irradiation operation with the image reading operation.

### <Configuration of Imaging Console 2>

The imaging console 2 outputs the irradiation conditions and the image reading conditions to the imaging apparatus 1, controls the radiation imaging and the reading operation of the radiation images by the imaging apparatus 1, and transmits each frame image of the dynamic image obtained by the imaging apparatus 1 to the diagnostic console 3 by attaching information such as an identification ID for identifying the dynamic image, patient information, the imaging site, the irradiation conditions, the image reading conditions, the number (frame number) indicating the order of the imaging and such like to the frame image.

As shown in FIG. 1, the imaging console 2 is configured by including a control section 21, a storage section 22, an operation section 23, a display section 24 and a communication section 25, which are connected to each other via a bus 26.

The control section 21 is configured by including a CPU (Central Processing Unit), a RAM (Random Access Memory) and such like. According to operations of the operation section 23, the CPU of the control section 21 reads out system programs and various processing programs stored in the storage section 22 to load the programs into the RAM, executes various types of processing in accordance with the loaded programs, and integrally controls operations of the sections in the imaging console 2 and the irradiation operation and the reading operation of the imaging apparatus 1.

The storage section 22 is configured by including a non-volatile semiconductor memory and a hard disk. The storage section 22 stores various programs to be executed by the control section 21, parameters necessary for executing processing by the programs, and data of processing results. The storage section 22 stores the irradiation conditions and the image reading conditions corresponding to the imaging site (here, chest). The various programs are stored in a form of readable program code, and the control section 21 executes an operation according to the program code as needed.

The operation section 23 is configured by including a keyboard including cursor keys, numeric keys and various function keys and a pointing device such as a mouse. The operation section 23 outputs instruction signals input by key operations to the keyboard or mouse operations to the control section 21. The operation section 23 may include a touch panel on the display screen of the display section 24. In this case, the operation section 23 outputs the instruction signals input via the touch panel to the control section 21.

The display section 24 is configured by a monitor such as an LCD (Liquid Crystal Display) and a CRT (Cathode Ray Tube), and displays the instructions input from the operation section 23, data and such like in accordance with instructions of display signals input from the control section 21.

The communication section 25 includes a LAN adapter, a modem, a TA (Terminal Adapter) and such like, and controls the data transmission and reception with the apparatuses connected to the communication network NT.

### <Configuration of Diagnostic Console 3>

The diagnostic console 3 is an image analysis apparatus for supporting a doctor in diagnosis by performing image analysis processing to the dynamic image (medical image) obtained from the imaging console 2 to generate an analysis result image and displaying the dynamic image and the analysis result image.

As shown in FIG. 1, the diagnostic console 3 is configured by including a control section 31, a storage section 32, an operation section 33, a display section 34 and a communication section 35, which are connected to each other via a bus 36.

The control section 31 is configured by including a CPU, a RAM and such like. According to operations of the operation section 33, the CPU of the control section 31 reads out system programs stored in the storage section 32 and various processing programs to load them into the RAM, executes various types of processing including after-mentioned image analysis processing and display control processing in accordance with the loaded programs, and integrally controls operations of the sections in the diagnostic console 3. The control section 31 functions as an analysis result image generation section and a display control section.

The storage section 32 is configured by including a non-volatile semiconductor memory, a hard disk and such like. The storage section 32 stores various programs including a program for executing the after-mentioned image analysis processing and the display control processing by the control section 31, parameters necessary for executing processing by the programs and data of processing results. The various programs are stored in a form of readable program code, and the control section 31 executes an operation according to the program code as needed.

The operation section 33 is configured by including a keyboard including cursor keys, numeric keys and various function keys and a pointing device 331 such as a mouse, and outputs instruction signals input by key operations to the keyboard and mouse operations to the control section 31. The operation section 33 may include a touch panel on the display screen of the display section 34. In this case, the operation section 33 outputs instruction signals, which were input via the touch panel, to the control section 31. The embodiment is described by taking, as an example, a case where a pointing device 331 is the mouse. However, the present invention is not limited to this. The operation section 33 functions as a setting section.

The display section 34 is configured by including a monitor such as an LCD and a CRT, and performs various displays in accordance with instructions of display signals input from the control section 31.

The communication section 35 includes a LAN adapter, a modem, a TA and such like, and controls data transmission and reception with the apparatuses connected to the communication network NT. The communication section 35 functions as an acquisition section.

### <Operation of Image Analysis System 100>

Next, the operation of the image analysis system 100 will be described.

First, dynamic imaging of a subject M is performed by the imaging apparatus 1 and the imaging console 2, and a dynamic image (a plurality of frame images indicating the dynamic state) of the subject is obtained. Each of the obtained frame images is accompanied by information such as an identification ID for identifying the dynamic image, the patient information, the imaging site, the irradiation conditions, the image reading conditions and the number (frame number) indicating the order of the imaging and transmitted to the diagnostic console 3.

In the diagnostic console 3, when a series of frame images of the dynamic image is obtained from the imaging console 2 by the communication section 35, analysis result images are generated by executing image analysis processing in cooperation between the control section 31 and a program stored in the storage section 32, and the generated analysis result images are stored in the storage section 32. Hereinafter, the embodiment is described by taking, as an example, a case where the dynamic image transmitted from the imaging console 2 is a chest dynamic image.

In the image analysis processing, the obtained dynamic image is analyzed for each of a plurality of sub-regions, the analysis result images each indicating analysis results at positions of the respective sub-regions in the medical image are generated, and each of the frame images of the dynamic image and the analysis result images generated from the frame image are stored in the storage section 32 so as to be associated with each other (for example, accompanied by the identification ID and the frame number) as related images. For example, on the basis of the dynamic image, ventilation analysis and blood flow analysis are performed, and a ventilation analysis result image and a blood flow analysis result image are generated.

For example, the ventilation analysis result image can be generated as follows.

First, lung field regions in each of the frame images of the dynamic image are divided into sub-regions each being formed of one or a plurality of pixel (s), and signal value (s) (density value (s)) of the pixel (s) in each of the sub-regions is replaced with a representative value (for example, average value, median value or the like) of the signal value (s) in the sub-region. Next, each of the sub-regions is associated between the plurality of frame images. For each of the sub-regions, a difference value of signal values between adjacent frame images is calculated by filtering the temporal change in the signal value of the pixel (s) in the sub-region with a low pass filter (for example, cutoff frequency 0.5 Hz) in a time direction. There are generated images each showing, on the sub-regions in each of the frame images, respective colors corresponding to the difference values calculated between the adjacent frames, and an interframe difference image arranging each of the generated images as one frame in the chronological order is generated as the ventilation analysis result image. The interframe difference image generated by the above method is an image indicating the signal change by ventilation in each of the sub-regions since the signal change by blood flow in each of the sub-regions is removed.

For example, the blood flow analysis result image can be generated as follows.

First, the lung field regions in each of the frame images of the dynamic image are divided into sub-regions each of which is formed of one or a plurality of pixel (s), and signal value (s) (density value(s)) of the pixel(s) in each of the sub-regions is replaced with a representative value (for example, average value, median value or the like) of the signal value(s) in the sub-region. Next, each of the sub-regions is associated between the plurality of frame images. For each of the sub-regions, a difference value of signal values between adjacent frame images is calculated by filtering the temporal change in the signal value of the pixel(s) in the sub-region with a high pass filter (for example, cutoff frequency 0.7 Hz) in a time direction. There are generated images each showing, on the sub-regions in each of the frame images, respective colors corresponding to the difference values calculated between the adjacent frames, and an interframe difference image arranging each of the generated images as one frame in the chronological order is generated as the blood flow analysis result image. The interframe difference image generated by the above method is an image indicating a signal change by blood flow in each of the sub-regions since the signal change by ventilation in each of the sub-regions is removed.

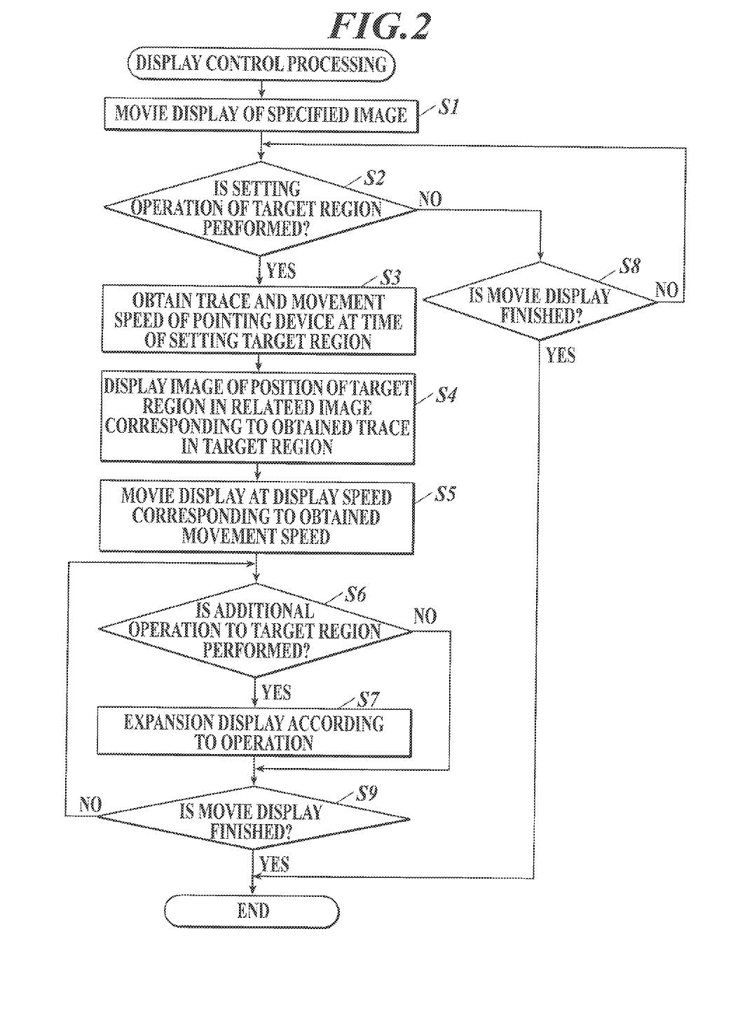

When an image to be displayed is specified by the operation section 33 from among the dynamic image or the analysis result images stored in the storage section 32, the display control processing shown in FIG. 2 is executed in cooperation between the control section 31 and the program stored in the storage section 32.

In the display control processing, first, the specified image (dynamic image or analysis result image) is displayed on the display section 34 (step S1). In step S1, movie display is performed for the specified image, for example.

Next, whether setting operation of a target region R was performed by the pointing device 331 (step S2).

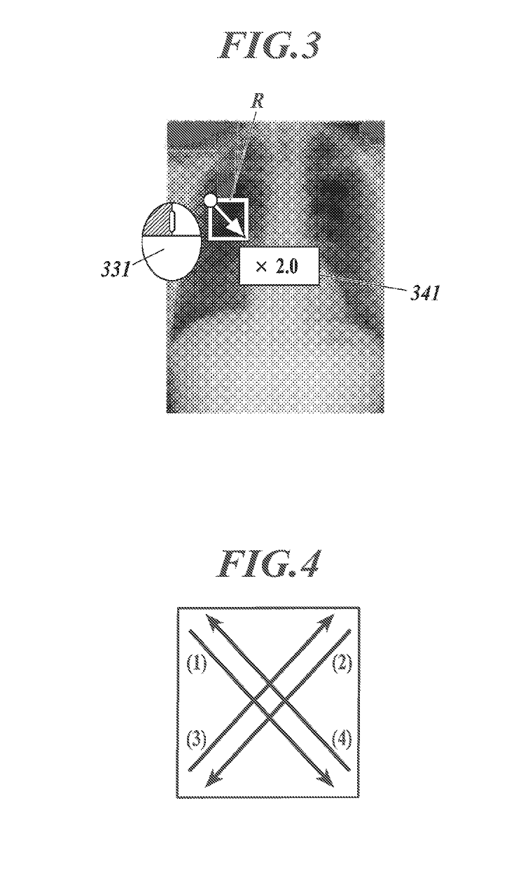

In a case of setting the target region R (rectangular region) with the pointing device 331, as shown in FIG. 3, the user performs an operation of specifying a start point with the pointing device 331, moving the pointer toward an end point while maintaining the specification with the pointing device 331, and releasing the specification with the pointing device 331 at the end point.

If it is not determined that the setting operation of the target region R was performed by the pointing device 331 (step S2: NO), whether the movie display is finished is determined (step S8). If it is not determined that the movie display is finished (step S8: NO), the processing returns to step S1. If it is determined that the movie display is finished (step S8: YES), the display control processing ends.

On the other hand, if it is determined that the setting operation of the target region R was performed with the pointing device 331 (step S2: YES), information regarding the movement of the pointing device 331 when the target region R was set, specifically, the trace and the movement speed is obtained (step S3).

As the trace of the pointing device 331 at the time of setting one target region R, there can be four traces as shown by the traces (1) to (4) in FIG. 4. In addition, the speed of moving the pointing device 331 from the start point to the end point can be changed freely by the user.

Thus, in the embodiment, for each type of image for which the target region R was set, different types of related images to be displayed on the target region R are assigned in advance to the respective four traces at the time of setting the target region R shown by the traces (1) to (4) in FIG. 4. For example, in a case where the target region R was set for a dynamic image, the ventilation analysis result image and the blood flow analysis result image are respectively assigned to the traces (1) and (2). Other analysis result images may be assigned to the traces (3) and (4). The display speed V of the moving image to be displayed on the display section 34 is calculated on the basis of the movement speed of the pointing device 331 when the target region R was set. The display speed V is, for example, calculated by the following (Expression 1) in which the movement speed of the pointing device 331 when the target region was set is V1. The reference display speed and the reference movement speed are determined in advance.

V=reference display speed×V1/(reference movement speed) (Expression 1)

By the user performing the setting operation of the target region R, it is possible to specify the type of related image to be displayed in the set target region R and the display speed of the moving image on the display section 34. It is preferable that an indicator 341 indicating the display speed is displayed as shown in FIG. 3 at the time of the setting operation of the target region R so that the user can grasp the display speed.

When the trace and the movement speed of the pointing device 331 at the time of setting the target region R are obtained, there is displayed, at the position of the set target region R, an image of the position corresponding to the target region R in the type of related image corresponding to the trace obtained in step S3 among the related images stored so as to be associated with the displayed image (step S4), and the entire image which is currently displayed is displayed by movie display at the display speed corresponding to the obtained movement speed (step S5).

FIG. 5A shows an example of displaying an analysis result image in the target region R on the dynamic image. As shown in FIG. 5A, by displaying the analysis result image of the target region R in the target region R on the dynamic image, the user can easily observe the analysis result of the target region R without moving his/her gaze. Furthermore, since the anatomical position of the analysis result image can be easily grasped by the surrounding dynamic image, it is possible to improve the diagnosis performance.

FIG. 5B shows an example of displaying a blood flow analysis result image in the target region R on the ventilation analysis result image. As shown in FIG. 5B, by displaying another analysis result image of a target region R in the target region R on the analysis result image, the user can easily observe another analysis result of the target region R without moving his/her gaze.

Next, whether an additional operation to the target region R was performed with the pointing device 331 is determined (step S6).

If it is not determined that the additional operation to the target region R was performed with the pointing device 331 (step S6: NO), the processing proceeds to step S9.

On the other hand, if it is determined that the additional operation to the target region R was performed with the pointing device 331 (step S6: YES), expansion display of target region R is performed according to the additional operation (step S7), and the processing proceeds to step S9.

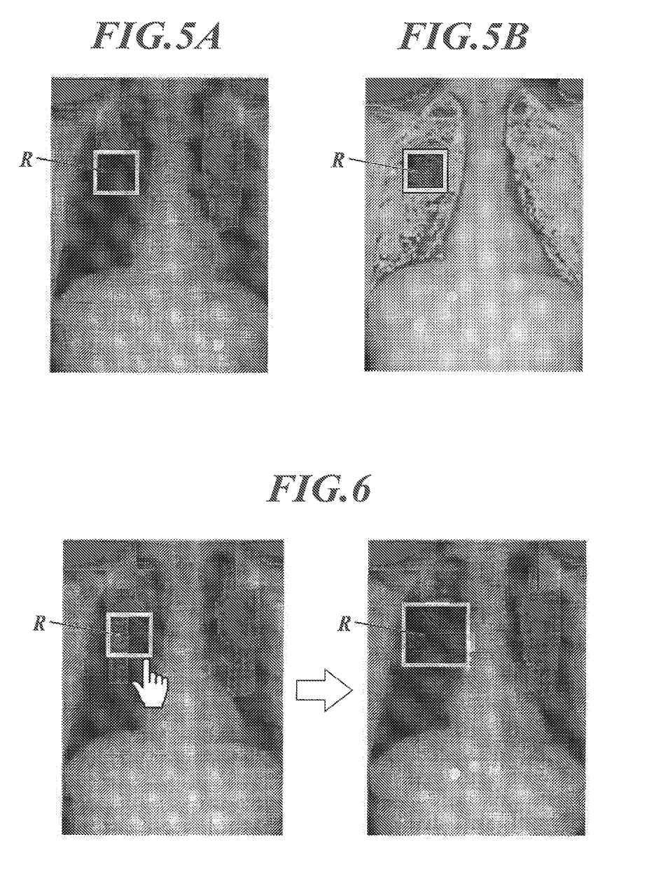

In step S7, in a case where an additional operation is performed by specifying and moving a corner of the target region R with the pointing device 331 as shown in FIG. 6, for example, the target region R is enlarged or reduced in accordance with the operation. Accordingly, since the size of the target region R can be changed by an easy operation, it is possible to easily perform local observation to comprehensive observation of the related image.

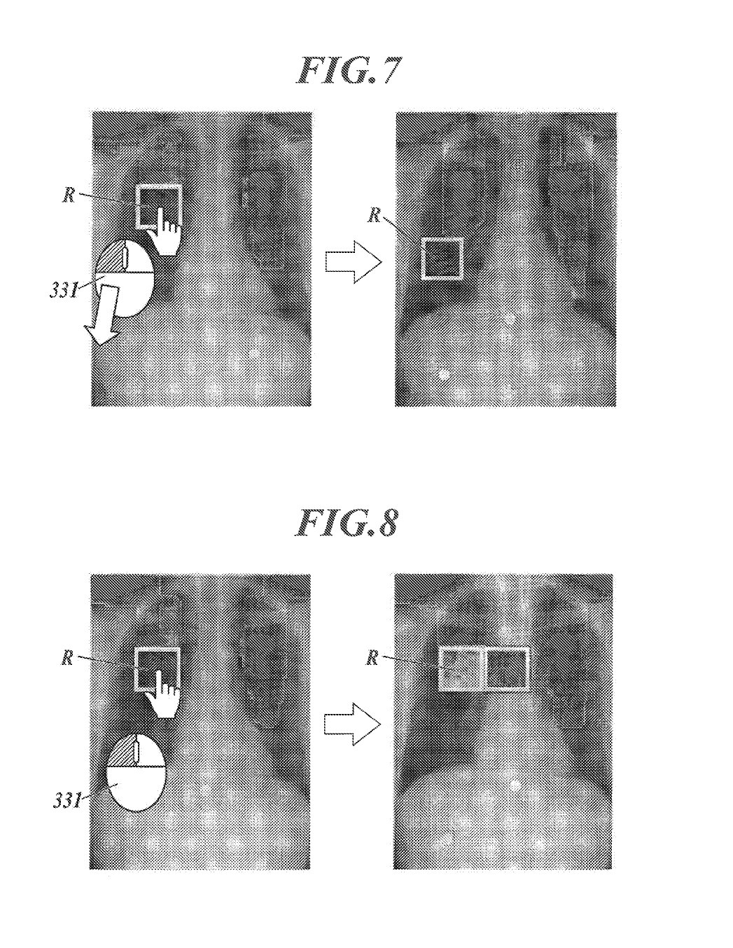

In a case where an additional operation is performed by dragging and dropping the target region R with the pointing device 331 as shown in FIG. 7, for example, the target region R is moved to the dropping destination and a related image of the position corresponding to the target region R at the movement destination is displayed. Thus, since the target region R can be moved easily, it is not necessary to set the target region R again for each region to be observed.

In a case where an additional operation is performed by double clicking the target region R with the pointing device 331 as shown in FIG. 8, for example, the related image displayed in the target region R slides to a neighborhood of the target region R, and another type of related image is displayed at the original position of the target region R. Thus, it is possible to observe a plurality of related images of a same target region R on a single image.

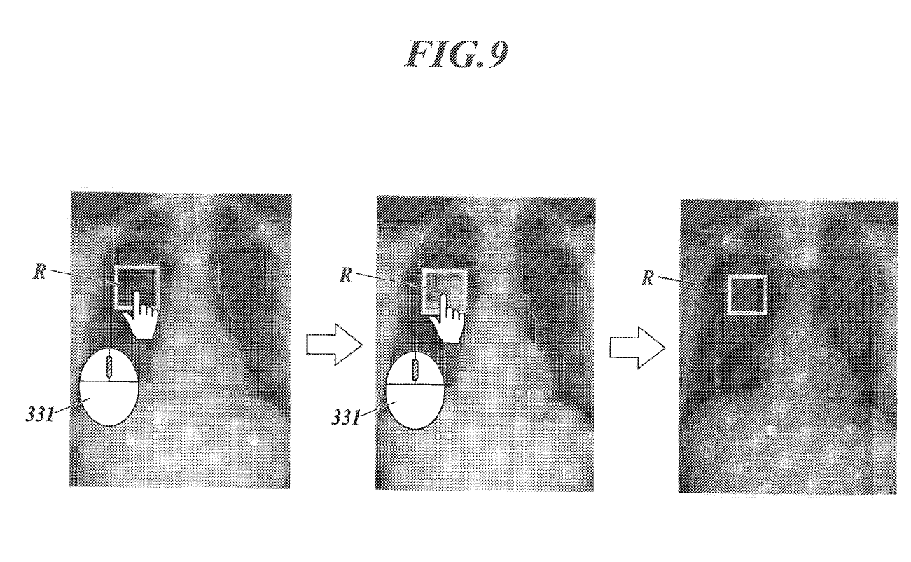

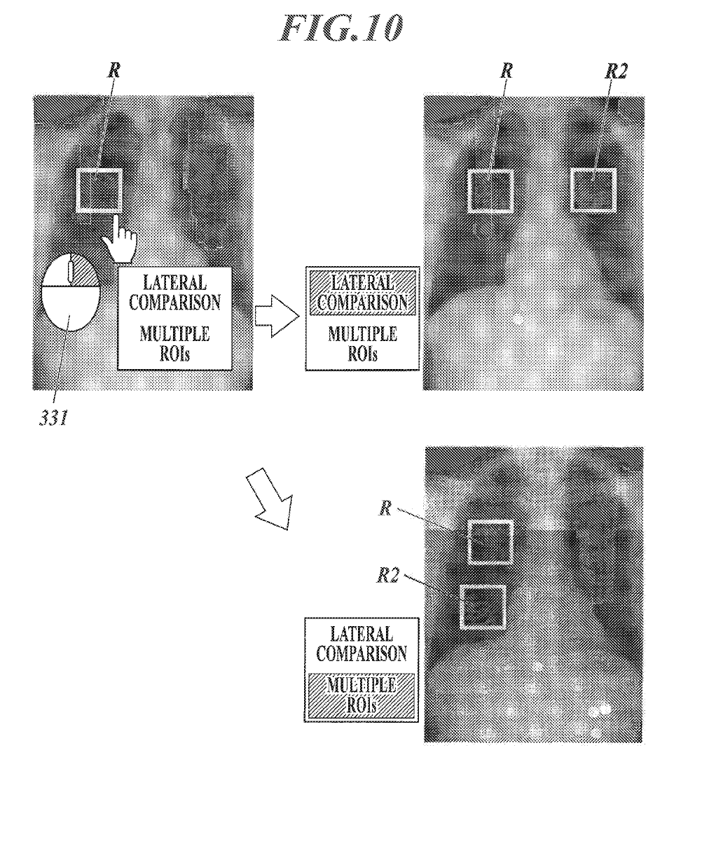

In a case where an additional operation is performed by locating the cursor of the pointing device 331 on the target region R and moving the wheel of the pointing device 331 as shown in FIG. 9, for example, a related image is displayed by a switch display in the target region R according to the wheel operation. Thus, it is possible to observe the dynamic image and the analysis result images of the target region R in order on a single image.

The image to be displayed in the target region R may be automatically switched by each predetermined time without performing the switching by the wheel operation.

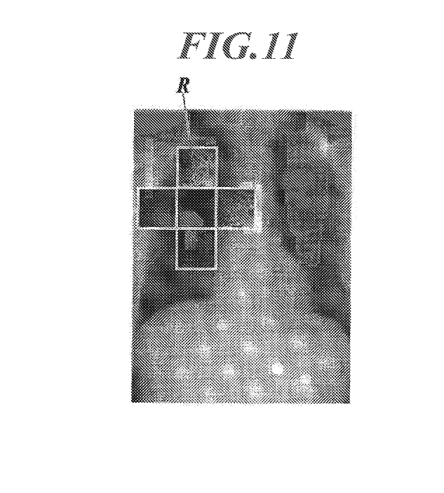

In a case where an additional operation is performed by selecting an item of “lateral comparison” from items displayed by a right click of the target region R with the pointing device 331 as shown in FIG. 10, for example, a target region R2 which is the same size as the target region R is set at the position corresponding to the target region R in the other left or right lung field (for example, the position which is symmetrical to the target region R with respect to the midline drawn halfway between the left and right lung fields), and a same type of related image (related image of the position corresponding to the target region R2) as the image displayed in the original target region R is displayed in the target region R2. Thus, it is possible to easily compare the left and right lung fields.

In a case where an additional operation is performed by selecting an item “multiple ROIs” from the items displayed by a right click to the target region R with the pointing device 331 as shown in FIG. 10, for example, a target region R2 is added to the lung field in the same side as the lung field where the target region R is displayed. Thus, it is possible to easily compare a plurality of target regions in the same lung field.

In step S9, whether the movie display is finished is determined (step S9). If it is not determined that the movie display is finished (step S9: NO), the processing returns to step S6. If it is determined that the movie display is finished (step S9: YES), the display control processing ends.

As described above, according to the diagnostic console 3, the control section 31 generates analysis result images by performing analysis for each of a plurality of sub-regions in a medical image obtained by the communication section 35, and stores the medical image and the analysis result images in the storage section 32 as related images so as to be associated with each other. When display of the medical image or an analysis result image is instructed from the operation section 33, the control section 31 controls the display section 34 to display the specified image. When a target region R is set by an operation with the pointing device 331 on the medical image or the analysis result image displayed on the display section 34, the control section 31 displays an image of the position, which is corresponding to the target region R in the related image, at the position of the target region R which was set with the pointing device 331 on the displayed medical image or the analysis result image.

Accordingly, since the related image of the position corresponding to the target region R is displayed at the position of the target region R which was set on the medical image or the analysis result image, the user does not need to move his/her gaze between a plurality of images to associate the target region R, and it is possible to easily observe the related image of the position corresponding to the target region. Furthermore, since only the related image of the corresponding position is displayed in the target region R, the user can perform observation with concentration without distracting his/her gaze to information other than the image of the position corresponding to the target region R in the related image.

The control section 31 obtains information regarding a movement of the pointing device 331 when the target region R was set with the pointing device 331, and performs display control of the display section 34 on the basis of the obtained information. Accordingly, since the user does not need to newly perform a setting operation regarding display, it is possible to improve the operability.

For example, the control section 31 obtains the trace of the pointing device 331 when the target region R was set with the pointing device 331, and displays a related image of the type which was assigned in advance to the obtained trace at the position of the target region R. Accordingly, the user can set the type of related image to be displayed in the target region R without newly performing a setting operation.

For example, the control section 31 obtains a movement speed of the pointing device 331 when the target region R was set with the pointing device 331, and performs movie display of the image displayed on the display section 34 at a display speed corresponding to the obtained movement speed. Accordingly, the user can display the moving image at the desired display speed without newly performing a setting operation.

Furthermore, the control section 31 changes the position, the size or the number of the target region R or changes the image to be displayed in the target region R according to the operation which was performed with the pointing device 331 with respect to the target region R on the image displayed on the display section 34. Accordingly, the user can easily change the position, the size or the number of the target region R or the image to be displayed with an easy operation to the target region R.

The description in the embodiment is an example of a preferred image analysis system according to the present invention, and the present invention is not limited to the description.

For example, in the embodiment, when a target region R is set on a dynamic image or an analysis result image, a related image corresponding to the trace when the target region R was set is displayed at the position of the set target region R. However, as shown in FIG. 11, related image (s) may be displayed around the set target region R. Thus, it is possible to observe the related image (s) of the position corresponding to the target region R while observing the target region R of the displayed image. Furthermore, in a case where there is a plurality of related images, it is possible to easily observe the target region R of the displayed image and the plurality of related images on a single image.

The embodiment has been described by taking, as an example, a case where the medical image is a dynamic image (moving image). However, the medical image may be a still image. The embodiment has been described by taking, as an example, a case where the medical image is an image obtained by capturing a chest. However, the medical image may be an image obtained by capturing another site.

In the embodiment, analysis result images are generated and stored in the storage section 32 in advance on the basis of the medical image in image analysis processing. When a target region R is set on the image displayed on the display section 34, a related image corresponding to the position of the set target region R is read out and displayed. However, in a case where the image to be displayed in the target region R is an analysis result image, analysis may be performed real time to the image at the position of the set target region R to display the analysis result image. In this case, an analysis parameter may be determined according to the movement speed of the pointing device 331 which was obtained when the target region R was set. The analysis parameter includes, for example, the above-mentioned cutoff frequency.

In the embodiment, the diagnostic console 3 includes all the functions as the analysis result image generation section, the display section, the setting section and the display control section. However, the functions may be dispersed to a plurality of apparatuses. For example, a server apparatus may include the function of the analysis result image generation section so that analysis result images generated by the server apparatus are stored so as to be associated with the medical image and a client reads the medical image and an analysis result image stored in the server apparatus to achieve the functions as the display section, the setting section and the display control section.

For example, the embodiment has been described for an example of using a hard disk or a semiconductor non-volatile memory and such like as a computer readable medium of programs according to the present invention. However, the present invention is not limited to this example. A portable recording medium such as a CD-ROM can be applied as another computer readable medium. A carrier wave is also applied as the medium for providing program data according to the present invention via a communication line.

As for the other detailed configurations and detailed operations of apparatuses forming the image analysis system 100, modifications can be appropriately made within the scope of the present invention.

What is claimed is:

1. An image analysis system, comprising:
a display apparatus which displays a medical image or an analysis result image that shows analysis results at respective positions of a plurality of sub-regions in the medical image, the analysis results being obtained by performing analysis for the respective sub-regions in the medical image; and
a control apparatus which, when a target region is set by an operation of a pointing device on the medical image or the analysis result image that is displayed by the display apparatus, controls the display apparatus to display, at a position of the target region or around the target region, an image of a position corresponding to the target region in the medical image or the analysis result image which is different from an image displayed outside a range of the target region.

2. The image analysis system according to claim 1, wherein each of the medical image and the analysis result image is a moving image.

3. The image analysis system according to claim 2, wherein the control apparatus obtains information regarding a movement of the pointing device when the target region is set with the pointing device, and performs display control of the display apparatus on the basis of the obtained information.

4. The image analysis system according to claim 3, wherein the control apparatus obtains a trace of the pointing device when the target region is set with the pointing device, and controls the display apparatus to display an image of a type which is assigned in advance to the obtained trace at the position of the target region or around the target region.

5. The image analysis system according to claim 3, wherein the control apparatus obtains a movement speed of the pointing device when the target region is set with the pointing device, and controls the display apparatus to display a moving image which is displayed by the display apparatus at a display speed corresponding to the obtained movement speed.

6. The image analysis system according to claim 1, wherein the control apparatus changes a position, a size or a number of the target region or changes an image displayed in the target region according to the operation which is performed with the pointing device to the target region on an image displayed by the display apparatus.
